(19) United States
(12) Patent Application Publication
(10) Pub. No.: US 2019/0148710 A1
(43) Pub. Date: May 16, 2019

(54) LITHIUM BATTERIES

(71) Applicant: Panasonic Intellectual Property Management Co., Ltd., Osaka-shi, Osaka (JP)

(72) Inventors: Yasuyuki Kusumoto, Hyogo (JP); Miyuki Nakai, Osaka (JP)

(73) Assignee: Panasonic Intellectual Property Management Co., Ltd., Osaka-shi, Osaka (JP)

(21) Appl. No.: 16/313,367

(22) PCT Filed: Jul. 6, 2017
(86) PCT No.: PCT/JP2017/024774

§ 371 Date: Dec. 26, 2018

(30) Foreign Application Priority Data
Sep. 12, 2016 (JP) 2016-177269

(51) Int. Cl. H01M 4/06; H01M 4/50; H01M 4/583; H01M 6/16

(52) U.S. Cl. CPC H01M 4/06; H01M 4/50; H01M 4/5835; H01M 2004/027; H01M 6/166; H01M 6/168; H01M 6/164

(57) ABSTRACT

A lithium battery includes a positive electrode, a negative electrode containing lithium, and a lithium ion conductive nonaqueous electrolyte. The positive electrode includes at least one selected from the group consisting of manganese oxide and graphite fluoride. The lithium battery includes a powdery or fibrous material attached to at least a portion of a surface of the negative electrode opposed to the positive electrode. The nonaqueous electrolyte includes a nonaqueous solvent, a solute and additives. The solute includes LiClO₄. The additives include LiBF₄ and an oxyfluorophosphate salt.

### TECHNICAL FIELD

The present invention relates to lithium batteries. More particularly, the invention relates to lithium batteries having a reduced variation in open circuit voltage (OCV) after assembly.

### BACKGROUND ART

In recent years, electronic devices that are powered by lithium batteries are being applied to a wider range of applications. As a result of this trend, the temperatures at which such electronic devices are used tend to range more widely. In particular, those lithium batteries which use manganese oxide or graphite fluoride in a positive electrode and metallic lithium in a negative electrode are usable at a wide range of temperature and thus hold great promise.

Batteries using metallic lithium have a large voltage drop at low temperatures. Some approaches to enhancing their outputs are to attach a carbon material to the surface of a negative electrode, and to add LiBF₄ to a nonaqueous electrolyte (Patent Literature 1).

Meanwhile, it has been proposed that a monofluorophosphate salt and/or a difluorophosphate salt is added to a nonaqueous electrolytic solution to reduce the increase in battery resistance during storage at high temperatures (Patent Literature 2).

### CITATION LIST

### Patent Literature

PTL 1: International Publication No. WO 2015/64052

PTL 2: Japanese Published Unexamined Patent Application No. 2009-252681

### SUMMARY OF INVENTION

A porous carbon material tends to be permeated nonuniformly with a nonaqueous electrolyte, and therefore placing such a carbon material on the surface of a negative electrode tends to cause the open circuit voltage (OCV) to be unstable after battery assembly. Thus, such conventional batteries need to be preliminarily discharged or aged for an extended time in order to stabilize the OCV.

In light of the above circumstances, an aspect of the present disclosure resides in a lithium battery comprising a positive electrode, a negative electrode containing lithium, and a lithium ion conductive nonaqueous electrolyte, wherein the positive electrode includes at least one selected from the group consisting of manganese oxide and graphite fluoride; the lithium battery includes a powdery or fibrous material attached to at least a portion of a surface of the negative electrode opposed to the positive electrode; the nonaqueous electrolyte includes a nonaqueous solvent, a solute and additives; the solute includes LiClO₄; and the additives include LiBF₄ and an oxyfluorophosphate salt.

Another aspect of the present disclosure resides in a lithium battery comprising a positive electrode, a negative electrode containing lithium, and a lithium ion conductive nonaqueous electrolyte, wherein the positive electrode includes at least one selected from the group consisting of manganese oxide and graphite fluoride; the lithium battery includes a powdery or fibrous material attached to at least a portion of a surface of the negative electrode opposed to the positive electrode; the nonaqueous electrolyte includes a nonaqueous solvent and a solute; the solute includes LiClO₄; and the negative electrode includes elementary boron and elementary phosphorus.

According to the present disclosure, the variation in OCV of lithium batteries after assembly is reduced, and thus preliminary discharging or aging can be simplified.

### BRIEF DESCRIPTION OF DRAWINGS

FIG. 1 is a sectional view illustrating an example of coin-type lithium batteries according to an embodiment of the present invention.

FIG. 2A is a sectional view illustrating a modified example of coin-type lithium batteries according to an embodiment of the present invention.

FIG. 2B is a bottom view of the modified example shown in FIG. 2A.

FIG. 3A is a sectional view illustrating a modified example of coin-type lithium batteries according to an embodiment of the present invention.

FIG. 3B is a bottom view of the modified example shown in FIG. 3A.

FIG. 4A is a sectional view illustrating a modified example of coin-type lithium batteries according to an embodiment of the present invention.

FIG. 4B is a bottom view of the modified example shown in FIG. 4A.

FIG. 5A is a sectional view illustrating a modified example of coin-type lithium batteries according to an embodiment of the present invention.

FIG. 5B is a bottom view of the modified example shown in FIG. 5A.

### DESCRIPTION OF EMBODIMENTS

Lithium batteries according to the present invention comprise a positive electrode, a negative electrode containing lithium, and a lithium ion conductive nonaqueous electrolyte, and have the following common features.

(i) The positive electrode includes at least one selected from the group consisting of manganese oxide and graphite fluoride.

(ii) The lithium battery includes a powdery or fibrous material attached to at least a portion of a surface of the negative electrode opposed to the positive electrode. The powdery or fibrous material forms a porous layer on the surface of the negative electrode.

(iii) The nonaqueous electrolyte includes a nonaqueous solvent and a solute, and the solute includes LiClO₄.

The lithium battery according to one of the aspects of the present invention, in addition to having the above common features, is characterized in that the nonaqueous electrolyte further includes additives, and the additives include LiBF₄ and an oxyfluorophosphate salt (first feature).

The lithium battery according to another aspect of the present invention, in addition to having the above common features, is characterized in that the negative electrode includes elementary boron and elementary phosphorus (second feature).

The elementary boron and the elementary phosphorus contained in the negative electrode in the second feature originate from, for example, LiBF₄ and an oxyfluorophosphate salt present in the nonaqueous electrolyte at the time of battery assembly. Thus, the lithium battery according to a still another aspect of the invention may have both the first feature and the second feature. The satisfaction of the first feature usually satisfies the second feature too. However, at least portions of the additive LiBF₄ and oxyfluorophosphate salt are consumed within the battery, and thus the satisfaction of the second feature does not necessarily satisfy the first feature.

The surface of the negative electrode opposed to the positive electrode indicates a region of the principal surface of the negative electrode opposed to the positive electrode which region overlaps the positive electrode when viewed in a direction normal to the principal surface. In the case of a coin-type battery, one of the two principal surfaces on the front and back of a disk-shaped negative electrode is opposed to a positive electrode.

The output of a battery at an initial stage of use can be enhanced by attaching a powdery or fibrous material onto the surface of a negative electrode so as to form a porous layer. However, the porous layer formed on the surface of the negative electrode tends to be permeated nonuniformly with a nonaqueous electrolyte, and this fact brings about a variation in OCV of assembled batteries. In contrast, the variation in OCV of lithium batteries after assembly is reduced by the introduction of the first feature and/or the second feature.

The reasons behind the reduced variation in OCV are probably as described below.

The oxyfluorophosphate salt and LiBF₄ present in the nonaqueous electrolyte react with each other in the presence of the negative electrode to form a quality film containing elementary boron (B) and elementary phosphorus (P) on the surface of the porous layer on the negative electrode and/or the surface of lithium in the negative electrode. This film enhances the permeability of the nonaqueous electrolyte into the porous layer and also enhances the wettability between the nonaqueous electrolyte and lithium. Further, when the porous layer is formed from the powdery or fibrous material in close contact with the negative electrode surface, solid lithium phases are diffused into the porous layer, and this diffusion probably adds a further enhancement in the permeability of the nonaqueous electrolyte into the porous layer. At the same time, the porous layer formed in close contact with the negative electrode surface makes larger the specific surface area of the negative electrode. This increase in the specific surface area of the negative electrode and the enhanced permeability of the nonaqueous electrolyte into the porous layer synergistically act to realize a marked increase in the area of contact between the negative electrode or lithium and the nonaqueous electrolyte. Probably due to the reasons described above, the negative electrode potentials are averaged immediately after the battery assembly and the OCV is stabilized.

Here, the phrase “after the battery assembly” means that a duration of time that is not less than 1 hour and not more than 8 hours has passed after the contact of the positive electrode and the negative electrode with the nonaqueous electrolyte, and the battery is not preliminarily discharged or aged yet.

The oxyfluorophosphate salt is a salt of oxyfluorophosphate anion. Examples of the oxyfluorophosphate anions include difluorophosphate anion and monofluorophosphate anion. The counter cation of the oxyfluorophosphate salt is not particularly limited but is preferably a monovalent to divalent cation. In particular, cations of elementary metals such as Li, Na and K, and ammonium ion are preferable, and Li cation (lithium ion) is more preferable. The oxyfluorophosphate salts may be used singly, or a plurality of such salts may be used in combination. Some example oxyfluorophosphate salts which are easily available are lithium monofluorophosphate (Li₂PO₃F) and lithium difluorophosphate (LiPO₂F₂).

In addition to LiBF₄ and the fluorophosphate salt, the additives that are added to the nonaqueous electrolyte preferably include a salt which has an inorganic anion containing sulfur and fluorine (a fluorine and sulfur-containing anion) (hereinafter, such a salt will be written as the fluorine and sulfur-containing salt). In this case, the additives can form a film of higher quality on the porous layer on the negative electrode and/or lithium in the negative electrode, and thereby realize further enhancements in the permeability of the nonaqueous electrolyte into the porous layer and the wettability between the nonaqueous electrolyte and lithium.

To ensure that the film formed will be of higher quality, the fluorine and sulfur-containing salt is preferably at least one selected from the group consisting of fluorosulfate (LiFSO₃) and lithium bisfluorosulfonylimide (LiN(FSO₂)₂).

Examples of the powdery or fibrous materials for forming a porous layer in contact with the negative electrode surface include carbon materials, materials which can be alloyed with Li, such as Al, Sn and Si, inorganic oxides and glass. Carbon materials are preferable. As the carbon materials, use may be made of, for example, natural graphites, artificial graphites, hard carbons, soft carbons, carbon blacks, carbon fibers and carbon nanotubes. Examples of the carbon blacks include acetylene black, Ketjen black, channel black, furnace black, lamp black and thermal black. These may be used singly, or two or more may be used in combination. In particular, carbon blacks are preferable, and the grain size thereof is preferably 5 nm to 8 μm.

The porous layer attached to the negative electrode surface will have an inhibitory effect on the formation of resistance components which are derived from the additives contained in the nonaqueous electrolyte. If there is no porous layer on the negative electrode surface, the additives tend to produce resistance components (for example, an insulating film based on LiF) during storage at high temperatures.

Hereinbelow, embodiments of the present invention will be described in greater detail.

A lithium battery according to an embodiment comprises a positive electrode, a negative electrode opposed to the positive electrode, and a lithium ion conductive nonaqueous electrolyte. A separator composed of a porous material capable of holding the nonaqueous electrolyte is preferably disposed between the positive electrode and the negative electrode.

### (Positive Electrodes)

For example, the positive electrode may be obtained by forming a disk from a mixture (a positive electrode mixture) including a positive electrode active material, a conductive agent and a binder, or by supporting a positive electrode mixture on a positive electrode current collector. Examples of the positive electrode current collectors include stainless steel, aluminum and titanium.

The positive electrode active material includes at least one of manganese oxide and graphite fluoride. A single or a mixture of positive electrode active materials may be used. Batteries containing manganese oxide exhibit a relatively high voltage and have excellent pulse discharge characteristics. Batteries containing graphite fluoride are relatively excellent in high-temperature storage characteristics and long-term reliability.

The oxidation number of manganese contained in the manganese oxide is typically 4, but is not limited thereto and may be slightly above or below 4. Some manganese oxides which may be used are MnO, Mn₃O₄, Mn₂O₃, MnO₂ and MnO₃. Manganese oxide based on manganese dioxide is generally used. The manganese oxide may be a mixed crystal including a plurality of types of crystalline states.

For example, the specific surface area of the manganese oxide is preferably 0.5 to 7 m²/g. By setting the specific surface area of the manganese oxide to this range, sufficient discharge reaction sites are ensured easily and the decomposition reaction of the nonaqueous electrolyte is suppressed more effectively. Thus, adopting such a specific surface area is advantageous for both storage characteristics and pulse discharge characteristics. The specific surface area of the manganese oxide is preferably 0.5 to 6 m²/g, and more preferably 3 to 6 m²/g.

The graphite fluoride is, for example a compound represented by the general formula: CFₓ (0.9≤x≤1.1). For example, the graphite fluoride is obtained by fluorinating petroleum coke or artificial graphite.

Examples of the conductive agents include natural graphites, artificial graphites, carbon blacks and carbon fibers. Examples of the carbon blacks include acetylene black, Ketjen black, channel black, furnace black, lamp black and thermal black. These may be used singly, or two or more may be used in combination. The amount of the conductive agent contained in the positive electrode mixture is, for example, 5 to 30 parts by mass per 100 parts by mass of the positive electrode active material.

Examples of the binders include olefin resins such as polyethylene and polypropylene, fluororesins such as polytetrafluoroethylene (PTFE), polyvinylidene fluoride, tetrafluoroethylene-hexafluoropropylene copolymer and vinylidene fluoride-hexafluoropropylene copolymer, styrene butadiene rubbers, fluororubbers and poly(meth)acrylic acid. These may be used singly, or two or more may be used in combination. The amount of the binder contained in the positive electrode mixture is, for example, 3 to 15 parts by mass per 100 parts by mass of the positive electrode active material.

The oxyfluorophosphate salt and LiBF₄ present in the nonaqueous electrolyte form a quality film containing elementary boron (B) and elementary phosphorus (P) also on the surface of the positive electrode. That is, the positive electrode can contain elementary boron and elementary phosphorus. The film formed on the positive electrode will homogenize the interface between the nonaqueous electrolyte and the positive electrode. Thus, the film on the positive electrode probably functions to stabilize the variation in interfacial resistance at the interface between the positive electrode and the nonaqueous electrolyte.

It is preferable that the positive electrode contain elementary boron in an amount of 0.5 μg to 8 μg, and more preferably in an amount of 2 μg to 8 μg per 1 mm² area of the surface of the positive electrode opposed to the negative electrode. It is preferable that the positive electrode contain elementary phosphorus in an amount of 1.5 μg to 15 μg, and more preferably in an amount of 3 μg to 12 μg per 1 mm² area of the surface of the positive electrode opposed to the negative electrode. When these amounts are met, the surface of the positive electrode can be seen as having a quality film containing necessary and sufficient amounts of B and P which is formed as a result of the positive electrode being opposed to the surface of the negative electrode coated with the powdery or fibrous material.

The nonaqueous electrolyte is poured during the battery assembly. At least part of elementary boron and elementary phosphorus contained in the oxyfluorophosphate salt and LiBF₄ shift to the battery members such as the positive electrode, the negative electrode and the separator, or constitute reaction products in the nonaqueous electrolyte, during preliminary discharging or aging after the battery assembly. The rest of additives that does not undergo such reactions remains as such.

At least part of elementary B and elementary P contained in the negative electrode and the positive electrode may be present in the negative electrode and/or the positive electrode before pouring of the nonaqueous electrolyte. It is, however, more preferable that elementary B and elementary P contained in the negative electrode and the positive electrode be elementary B and elementary P originating from the components of the nonaqueous electrolyte that has been poured.

The surface of the positive electrode opposed to the negative electrode indicates a region of the principal surface of the positive electrode opposed to the negative electrode which region overlaps the negative electrode when viewed in a direction normal to the principal surface. In the case of a coin-type battery, one of the two principal surfaces on the front and back of a disk-shaped positive electrode is opposed to a negative electrode.

### (Negative Electrodes)

The negative electrode includes at least either of metallic lithium and a lithium alloy. The lithium alloy is an alloy containing lithium and an element M other than lithium. The element M preferably includes at least one selected from the group consisting of Mg, Al, Ca, Ti, V, Cr, Mn, Fe, Co, Ni, Cu and Zn. The content of the element M contained in the lithium alloy is preferably not more than 20 at %. For example, the negative electrode may be obtained by punching a sheet of metallic lithium or a lithium alloy into a disk. The negative electrode may be attached to a negative electrode current collector. Examples of the negative electrode current collectors include copper, nickel and stainless steel.

A powdery or fibrous material is attached to at least a portion of the surface of the negative electrode opposed to the positive electrode. This configuration makes it possible to enhance the initial output of the battery and to reduce side reactions between the negative electrode surface and the nonaqueous electrolyte. When the positive electrode includes graphite fluoride, it is important to suppress the formation of LiF on the surface of the negative electrode.

The amount of the material attached to the surface of the negative electrode is preferably 0.02 mg to 10 mg per 1 cm² area of the surface of the negative electrode opposed to the positive electrode. This amount ensures that the permeability of the nonaqueous electrolyte into the porous layer will be effectively enhanced, the specific surface area will be effectively increased, and the formation of resistance components on the surface of the negative electrode will be effectively suppressed.

The surface of the negative electrode opposed to the positive electrode may be covered with the porous layer in any area proportion without limitation. For example, the proportion is 1 to 100%, preferably 30 to 100%, and more preferably 80 to 100% of the surface area. The higher the proportion of the area covered with the porous layer, the higher the above enhancement or suppressive effects. The surface covered with the porous layer may be distinguished from the uncovered surface by, for example, monochromatically processing a photograph of the surface of the negative electrode opposed to the positive electrode.

The powdery or fibrous material may be combined with a porous sheet-like holding material. In this case, the powdery or fibrous material may be held beforehand on the sheet-like holding material. When, for example, a powdery carbon material is used, an alcohol dispersion including the carbon material may be applied so as to coat or impregnate the holding material, and thereafter the holding material may be dried. A porous layer of good condition may be formed on the surface of the negative electrode by uniformly holding the carbon material on the sheet-like holding material. The holding material may be then attached to the surface of the negative electrode opposed to the positive electrode together with the powdery or fibrous material. This configuration facilitates the step of attaching the powdery or fibrous material to the surface of the negative electrode, and makes it possible to prevent the powdery or fibrous material from scattering or from being dispersed into the nonaqueous electrolyte during the battery assembly.

The holding material is preferably a fiber material, and particularly preferably a nonwoven fabric. A preferred material of such a nonwoven fabric is polypropylene or polyphenylenesulfide. The weight per area and the thickness of the nonwoven fabric are preferably 20 g/m² to 60 g/m², and 0.08 mm to 0.50 mm, respectively.

As already mentioned, the oxyfluorophosphate salt and LiBF₄ present in the nonaqueous electrolyte form a quality film containing elementary boron (B) and elementary phosphorus (P) on the surface of the porous layer on the negative electrode and/or the surface of lithium in the negative electrode. Here, the negative electrode preferably contains elementary boron in an amount of 0.1 μg to 3 μg, and more preferably in an amount of 0.6 μg to 2 μg per 1 mm area of the surface of the negative electrode opposed to the positive electrode. Further, the negative electrode preferably contains elementary phosphorus in an amount of 0.2 μg to 2.5 μg, and more preferably in an amount of 0.4 μg to 2 μg per 1 mm² area of the surface of the negative electrode opposed to the positive electrode. When these amounts are met, the surface of the negative electrode opposed to the positive electrode and covered with the powdery or fibrous material can be seen as having a quality film containing necessary and sufficient amounts of B and P.

### (Nonaqueous Electrolytes)

The nonaqueous electrolyte includes a nonaqueous solvent, a solute and additives. The additives are sometimes extinct in the complete battery as a result of being consumed in the formation of a film. Even in such a case, elementary boron and elementary phosphorus of additive origin are contained in the negative electrode.

LiClO₄ is an essential solute. By containing LiClO₄, the nonaqueous electrolyte attains excellent dielectric constant and conductivity. Further, LiClO₄ is highly compatible with cyclic carbonate esters and chain ethers. Incidentally, the use of LiBF₄ as a solute is not suitable because LiBF₄ has a high tendency to be consumed within the battery and causes a decrease in output, and also because the negative electrode comes to contain an excessively large amount of boron and it becomes difficult to form a quality film on the porous layer.

In addition to LiClO₄, a lithium salt such as LiPF₆, LiR¹SO₃ (R is a C₁₋₄ fluorinated alkyl group) or LiN(SO₂R²) (SO₂R³) [R² and R³ are each independently a C₁₋₄ fluorinated alkyl group] may be used as an additional solute. Such lithium salts may be used singly, or two or more may be used in combination. The total concentration of the solute(s) in the nonaqueous electrolyte is preferably 0.2 to 2.0 mol/L, more preferably 0.3 to 1.5 mol/L, and particularly preferably 0.4 to 1.2 mol/L. It is preferable that LiClO₄ represent at least 50 mass %, and more preferably at least 80 mass % of the solute(s).

In the lithium salt represented by LiR¹SO₃ (sulfonate salt), the C₁₋₄ fluorinated alkyl group R¹ is preferably a C₁₋₄ perfluoroalkyl group such as, specifically, perfluoromethyl, perfluoroethyl, perfluoropropyl or perfluorobutyl. In the lithium salt represented by LiN(SO₂R²) (SO₂R³) (imide salt), the C₁₋₄ fluorinated alkyl groups R² and R³ are preferably each a C₁₋₄ perfluoroalkyl group such as, specifically, perfluoromethyl, perfluoroethyl, perfluoropropyl or perfluorobutyl. These carbon-containing organic salts are suitable as solutes for the reasons that they are stable at the operating voltages of the battery and are unlikely to undergo side reactions.

Examples of the nonaqueous solvents include chain carbonate esters such as dimethyl carbonate (DMC), diethyl carbonate (DEC) and ethyl methyl carbonate (EMC), cyclic carbonate esters such as ethylene carbonate (EC), propylene carbonate (PC) and butylene carbonate (BC), chain ethers such as 1,2-dimethoxyethane (DME), 1,2-diethoxyethane (DEE) and ethoxymethoxyethane (EME), cyclic ethers such as tetrahydrofuran, 2-methyltetrahydrofuran, 1,3-dioxolane and 4-methyl-1,3-dioxolane, and cyclic carboxylate esters such as γ-butyrolactone. These may be used singly, or two or more may be used in combination.

The nonaqueous solvent preferably includes a cyclic carbonate ester which has a high boiling point, and a chain ether which exhibits a low viscosity even at a low temperature. The cyclic carbonate ester preferably includes at least one selected from the group consisting of propylene carbonate (PC) and butylene carbonate (BC), and is particularly preferably PC. The chain ether preferably includes dimethoxyethane (DME). In this case, the nonaqueous electrolyte preferably includes PC and/or BC, and DME in a total proportion of 40 to 98 mass %, more preferably 70 to 97 wt %, and particularly preferably 70 to 90 wt %. Such a nonaqueous solvent is advantageous in that the solvent is electrochemically stable at a wide range of low and high temperatures and also has a high conductivity. The volume ratio in which PC and/or BC, and DME are mixed, (PC and/or BC)/DME, is preferably 5/95 to 100/0, and more preferably 10/90 to 80/20.

By controlling the quantitative balance between B and P in the film containing elementary boron (B) and elementary phosphorus (P), the permeability of the nonaqueous electrolyte into the porous layer can be effectively enhanced, and also the wettability between the nonaqueous electrolyte and lithium can be effectively increased. Hereinbelow, preferred amounts in which the additives are used will be described.

The additives are consumed by preliminary discharging and aging after the battery assembly. The amounts in which the additives are used are preferably controlled so that the contents of the additives in the complete aged battery (the battery ready for shipment) will be in the following ranges.

The amount of LiBF₄ contained in the nonaqueous electrolyte in the complete battery is preferably 4 to 20 parts by mass, and more preferably 6 to 12 parts by mass per 100 parts by mass of the solute. When this amount is met, the amount of consumption of LiBF₄ inside the battery is optimized, and the quantitative balance between B and P contained in the film is improved, with the result that the enhancement effects described above are improved.

The amount of the oxyfluorophosphate salt contained in the nonaqueous electrolyte in the complete battery is preferably 0.2 to 2.5 parts by mass, and more preferably 0.5 to 2 parts by mass per 100 parts by mass of the solute. The ratio (M1/M2) of the mass of LiBF₄ (M1) to the mass of the oxyfluorophosphate salt (M2) contained in the nonaqueous electrolyte in the complete battery is preferably 2 to 20.

The amount of the fluorine and sulfur-containing salt contained in the nonaqueous electrolyte in the complete battery is preferably 1 to 200 parts by mass, and more preferably 40 to 160 parts by mass per 100 parts by mass of the solute. The ratio (M1/M3) of the mass of LiBF₄ (M1) to the mass of the fluorine and sulfur-containing salt (M3) contained in the nonaqueous electrolyte in the complete battery is preferably 0.05 to 20.

In a preferred embodiment of the composition of the nonaqueous electrolyte, for example, the nonaqueous solvent is a mixed solvent of PC and DME with a volume ratio PC/DME of 20/80 to 80/20, the solute includes not less than 90 mass % LiClO₄, and the solute concentration is 0.3 to 1.0 mol/L.

In the above case, the amount of LiBF₄ contained in the nonaqueous electrolyte is preferably 4 to 20 parts by mass per 100 parts by mass of LiClO₄, the amount of the oxyfluorophosphate salt is preferably 0.2 to 2.5 parts by mass per 100 parts by mass of LiClO₄, and the amount of the fluorine and sulfur-containing salt is preferably 1 to 200 parts by mass per 100 parts by mass of LiClO₄.

In the nonaqueous electrolyte before use in the assembly of the battery (immediately after prepared), the amount of LiBF₄ is preferably 2 to 6 mass %, and more preferably 2 to 4 mass % relative to the total mass of the nonaqueous electrolyte. The amount of the oxyfluorophosphate salt is preferably 0.5 to 4 mass %, and more preferably 1 to 3 mass % relative to the total mass of the nonaqueous electrolyte. The amount of the fluorine and sulfur-containing salt is preferably 0.5 to 8 mass %, and more preferably 2 to 6 mass % relative to the total mass of the nonaqueous electrolyte.

Next, methods for quantitatively determining the solutes and additives will be described.

### (i) Quantitative Determination of Solutes and Additives in Nonaqueous Electrolyte

First, the battery is disassembled, and the nonaqueous electrolyte held in the complete battery is collected. Next, the nonaqueous electrolyte is analyzed with an ion chromatograph to identify the types of salts contained as the solutes and additives.

In the case where the nonaqueous electrolyte includes any of ClO₄ ion, BF₄ ion, oxyfluorophosphate ion, and fluorine and sulfur-containing anion, the concentration thereof in the nonaqueous electrolyte may be determined by ion chromatography, and the concentrations of the solutes and additives contained in the nonaqueous electrolyte may be determined from the results of ion chromatography.

### (ii) Quantitative Determination of Elementary Boron (B) and Elementary Phosphorus (P) in Positive Electrode or Negative Electrode

First, the positive electrode, the negative electrode and the separator are removed from the complete battery, and the area is measured of the surface of the negative electrode opposed to the positive electrode (this area is identical to the area of the surface of the positive electrode opposed to the negative electrode).

Next, the whole of the positive electrode is collected and is dissolved with aqua regia. Make sure that the positive electrode active material constituting the positive electrode is completely dissolved.

Next, the whole of the negative electrode and separator is collected and is dissolved with aqua regia. The negative electrode may be soaked in aqua regia together with the porous layer and the separator. In the case where the porous layer is a composite including a sheet-like holding material, the negative electrode may be soaked in aqua regia together with the separator and the holding material. The powdery or fibrous material forming the porous layer, the holding material and the separator may remain undissolved in aqua regia, but the metallic lithium (the lithium alloy) forming the negative electrode should be completely dissolved.

Next, the aqueous solutions thus obtained are analyzed by elemental analysis based on ICP emission spectrometry to determine the concentrations of elementary boron (B) and elementary phosphorus (P) in the solutions. The absolute amounts of elementary boron and elementary phosphorus are calculated based on the concentrations, and are divided by the area described hereinabove. The amounts of elementary boron and elementary phosphorus per 1 mm² area may be thus determined.

In an embodiment of the present invention, both the positive electrode and the negative electrode preferably have a disk shape. Some example lithium batteries having such positive electrodes and negative electrodes are coin-type batteries and button-type batteries. Lithium batteries of the above configuration are suited for use as primary batteries.

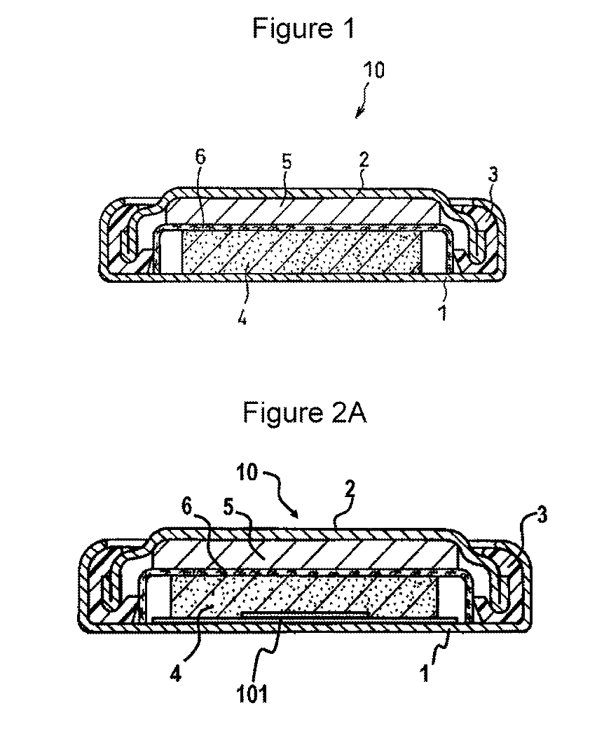

FIG. 1 is a sectional view illustrating an example of coin-type or button-type lithium batteries according to the present embodiment. However, the shape of the lithium batteries is not limited thereto and may be selected appropriately from various shapes such as, for example, cylindrical shapes, prismatic shapes, sheet shapes, flat shapes and laminate shapes.

A lithium battery 10 includes a positive electrode 4, a negative electrode 5, a separator 6 disposed between the positive electrode 4 and the negative electrode 5, and a nonaqueous electrolyte that is not shown. The positive electrode 4 is accommodated in a battery case 1 which also serves as a positive electrode terminal. The negative electrode 5 is bonded to the inner face of a sealing plate 2 which also serves as a negative electrode terminal. A carbon material (not shown) is attached to the surface of the negative electrode 5 opposed to the positive electrode 4. The opening of the battery case 1 is closed with the sealing plate 2. A gasket 3 is disposed along the periphery of the sealing plate 2. The open end of the battery case 1 is crimped inwardly so as to secure tightly the gasket 3 between the battery case 1 and the sealing plate 2. The inside of the battery is thus sealed.

For example, the separator 6 is a nonwoven fabric or a microporous film. Examples of the materials of the nonwoven fabrics and/or the microporous films include polyphenylenesulfide (PPS), polyethylene, polypropylene, polyethylene polypropylene mixture, and ethylene propylene copolymer.

Next, the present invention will be described in greater detail based on EXAMPLES.

### Example 1

### (1) Fabrication of Positive Electrode

5 Parts by mass of Ketjen black as a conductive agent, and 5 parts by mass of polytetrafluoroethylene (PTFE) as a binder were added to 100 parts by mass of manganese dioxide. These were mixed sufficiently to give a positive electrode mixture. The positive electrode mixture was shaped into a disk 15 mm in diameter and 3.0 mm in thickness and was dried at 200° C. A positive electrode was thus fabricated.

### (2) Fabrication of Negative Electrode

A 1.0 mm thick metallic lithium sheet was punched into a disk having a diameter of 16 mm. The punched disk was used as a negative electrode.

Separately, water and ethanol were added to acetylene black as a carbon material (average particle size of primary particles: 35 nm), and these were mixed sufficiently to give a dispersion. The dispersion was sprayed to one side of a 0.25 mm thick polypropylene (PP) nonwoven fabric as a holding material (mass per area: 25 g/m²), and was thereafter dried at 60° C. for 6 hours. The amount of the carbon material held on the holding material (the amount of the carbon material to be attached to the surface of the negative electrode) was 1.0 mg/cm². The composite (the carbon coat) thus obtained which was composed of the carbon material and the holding material was punched into a disk having a diameter of 15 mm.

### (3) Preparation of Nonaqueous Electrolyte

A nonaqueous solvent was obtained by mixing propylene carbonate (PC) and 1,2-dimethoxyethane (DME) in a volume ratio of 1:1. Using this nonaqueous solvent, a nonaqueous electrolyte was prepared which contained 0.5 mol/L LiClO₄ as a solute, and 84 parts by mass of LiBF₄ and 21 parts by mass of lithium difluorophosphate (LiPO₂F₂) per 100 parts by mass of the solute (LiClO₄). The solute was LiClO₄ alone.

### (4) Fabrication of Coin-Type Lithium Battery

A bottomed stainless steel battery case (a positive electrode terminal) having an opening was provided. The positive electrode and a separator were arranged in this order inside the battery case. The separator was a 0.45 mm thick polypropylene (PP) nonwoven fabric. Separately, a stainless steel sealing plate (a negative electrode terminal) was provided which had a PPS gasket disposed along its periphery. The negative electrode was bonded to the inner face of the plate, and the disk-shaped composite of the carbon material and the holding material was attached to the surface (the surface opposed to the positive electrode) of the negative electrode. The nonaqueous electrolyte was poured into the battery case and was brought into contact with the positive electrode and the separator. Thereafter, the opening of the battery case was closed with the sealing plate, and the open end of the battery case was crimped in contact with the periphery of the sealing plate.

Thereafter, the battery was preliminarily discharged at a constant current of 4 mA for 2 hours and was further allowed to stand (aged) at 45° C. for 3 days. A complete coin-type lithium battery (a battery A1) illustrated in FIG. 1 which corresponded to a battery ready for shipment was thus obtained.

### Example 2

A coin-type lithium battery (a battery A2) was fabricated in the same manner as the battery A1, except that the amount of lithium difluorophosphate contained in the nonaqueous electrolyte as prepared was changed to 42 parts by mass per 100 parts by mass of the solute (LiClO₄).

### Example 3

A coin-type lithium battery (a battery A3) was fabricated in the same manner as the battery A1, except that the amount of lithium difluorophosphate contained in the nonaqueous electrolyte as prepared was changed to 84 parts by mass per 100 parts by mass of the solute (LiClO₄).

### Example 4

A coin-type lithium battery (a battery A4) was fabricated in the same manner as the battery A2, except that 84 parts by mass of LiN(FSO₂)₂ was further added as an additive to the nonaqueous electrolyte per 100 parts by mass of the solute (LiClO₄).

### Comparative Example 1

A coin-type lithium battery (a battery B1) was fabricated in the same manner as the battery A2, except that the composite (the carbon coat) composed of the carbon material and the holding material was not attached to the surface of the negative electrode.

### Comparative Example 2

A coin-type lithium battery (a battery B2) was fabricated in the same manner as the battery A2, except that LiBF₄ was not added to the nonaqueous electrolyte.

### Comparative Example 3

A coin-type lithium battery (a battery B3) was fabricated in the same manner as the battery A2, except that lithium difluorophosphate was not added to the nonaqueous electrolyte.

### Comparative Example 4

A coin-type lithium battery (a battery B4) was fabricated in the same manner as the battery B3, except that the composite (the carbon coat) composed of the carbon material and the holding material was not attached to the surface of the negative electrode.

### [Evaluation of Batteries]

The batteries of EXAMPLES and COMPARATIVE EXAMPLES were evaluated as described below.

<Initial CCV after Aging>

The initial closed circuit voltage (CCV) after aging was measured. Here, the voltage after 200 ms of 10 mA discharging was measured.

<OCV Before and after Aging>

Ten batteries were fabricated in accordance with each of EXAMPLES and COMPARATIVE EXAMPLES. The OCV was measured before and after aging performed immediately after the battery assembly. The difference (ΔOCV) between the highest OCV and the lowest OCV of the ten batteries was determined. The variation in OCV is greater and the OCV is more unstable with increasing value of ΔOCV.

<IR Before and after Aging>

Ten batteries were fabricated in accordance with each of EXAMPLES and COMPARATIVE EXAMPLES. The IR (the internal resistance at 1 kHz) was measured before and after aging performed immediately after the battery assembly. The difference (ΔIR) between the highest IR and the lowest IR of the ten batteries was determined. The variation in IR is greater and the IR is more unstable with increasing value of ΔIR.

### <Concentrations of Additives in Nonaqueous Electrolyte>

The nonaqueous electrolyte was extracted from the aged battery and was analyzed on an ion chromatograph to determine the amounts of the solute (LiClO₄) and the additives that had not been consumed. The concentration of the solute in the nonaqueous electrolyte was 0.5 mol/L and was substantially unchanged from the concentration at the preparation of the nonaqueous electrolyte.

The analysis results and the evaluation results of EXAMPLES and COMPARATIVE EXAMPLES are described in Table 1 and Table 2, respectively.

TABLE 1

| | Carbon | | | | Initial CCV |
|---|---|---|---|---|---|
| Batteries | coat | LiBF₄* | LiPO₂F₂* | LiN(FSO₂)₂* | (V) |
| A1 | Present | 8.8 | 0.5 | 0 | 3.19 |
| A2 | Present | 8.8 | 1.0 | 0 | 3.16 |
| A3 | Present | 8.8 | 2.0 | 0 | 3.11 |
| A4 | Present | 8.8 | 1.0 | 84 | 3.15 |
| B1 | Absent | 8.8 | 1.0 | 0 | 3.06 |
| B2 | Present | 0 | 1.0 | 0 | 3.04 |
| B3 | Present | 8.8 | 0 | 0 | 3.21 |
| B4 | Absent | 8.8 | 0 | 0 | 3.14 |

*parts by mass per 100 parts by mass of solute

TABLE 2

| | ΔOCV (mV) | | ΔIR (Ω) | |
|---|---|---|---|---|
| Batteries | Before aging | After aging | Before aging | After aging |
| A1 | 7 | 6 | 0.3 | 0.2 |
| A2 | 3 | 4 | 0.2 | 0.1 |
| A3 | 11 | 4 | 0.4 | 0.2 |
| A4 | 2 | 2 | 0.1 | 0.1 |
| B1 | 26 | 2 | 1.1 | 0.3 |
| B2 | 22 | 13 | 1.4 | 0.6 |
| B3 | 23 | 10 | 1.0 | 0.4 |
| B4 | 20 | 3 | 1.2 | 0.7 |

As shown in Table 1, the batteries of EXAMPLES and COMPARATIVE EXAMPLES exhibited sufficient values of initial CCV. In each of EXAMPLES, substantially no variation in OCV was seen before aging. This result means that the preliminary discharging and aging of assembled batteries can be simplified or omitted. Further, in each of EXAMPLES, there was substantially no variation in IR before aging. This result too means that the preliminary discharging and aging of assembled batteries can be simplified or omitted. The upper limit of ΔOCV indicating an acceptable variation is empirically estimated to be about 15 mV, and the upper limit of ΔIR is empirically estimated to be about 1.0Ω.

In contrast, the batteries of COMPARATIVE EXAMPLES showed a variation in OCV before aging, and the ΔOCV was more than 20 mV in each case. Further, the IR before aging was variable in each of COMPARATIVE EXAMPLES, and the ΔIR was 1.0Ω or more in each case. The batteries of COMPARATIVE EXAMPLES did not have the carbon coat (B1 and B4), did not contain LiBF₄ as an additive (B2), or did not contain LiPO₂F₂ as an additive (B3).

### <Amounts of Elementary B and Elementary P Contained in Positive Electrode or Negative Electrode>

The positive electrode and the negative electrode were removed from the aged battery and were each dissolved with aqua regia to give solutions. The negative electrode was soaked in aqua regia together with the separator, acetylene black and the holding material. Thus, the complete solution of metallic lithium in the negative electrode contained residues of the separator, acetylene black and the PP nonwoven fabric. The residues were removed by filtration. Next, the concentrations of elementary boron (B) and elementary phosphorus (P) in the solutions were measured by elemental analysis, and were converted to the amounts of elementary boron and elementary phosphorus per 1 mm area of the positive electrode or the negative electrode opposed to each other.

The amounts of elementary B and elementary P in EXAMPLES and COMPARATIVE EXAMPLES are described in Table 3.

TABLE 3

| | Amounts (μg/mm²) of elementary | | | |
|---|---|---|---|---|
| | B and elementary P after aging | | | |
| | B in positive | P in positive | B in negative | P in negative |
| Batteries | electrode | electrode | electrode | electrode |
| A1 | 2.0 | 3.2 | 0.6 | 0.4 |
| A2 | 3.4 | 6.4 | 1.1 | 0.9 |
| B1 | 3.7 | 6.9 | 0.04 | 0.05 |
| B2 | ND | 6.2 | ND | 0.8 |
| B3 | 5.2 | ND** | 1.1 | ND |

**ND indicates that the amount was below the detection limit.

In each of EXAMPLES, elementary boron (B) and elementary phosphorus (P) were detected in the positive electrode and the negative electrode after aging. From this result, it is understood that films which contained B and P originating from the oxyfluorophosphate salt and LiBF₄ had been formed on the positive electrode and the negative electrode. The film on the positive electrode probably has a function to stabilize the variation in interfacial resistance at the interface between the positive electrode and the nonaqueous electrolyte.

In the comparative example battery B1 which did not have any carbon coat, elementary boron (B) and elementary phosphorus (P) were detected but their amounts were trace. Elementary boron (B) was not detected in the negative electrode of the battery B2, and elementary phosphorus (P) was not detected in the negative electrode of the battery B3. From these results, it is understood that a quality film had not been formed on at least the negative electrode.

Reasonable effects will be obtained even if the contents of the additives in the nonaqueous electrolyte are reduced (or increased). The same tendencies as those in EXAMPLES will be obtained even when the amount of the carbon material (acetylene black) attached to the surface of the negative electrode opposed to the positive electrode is changed in the range of 0.02 to 10.0 mg/cm².

While coin-type lithium batteries (primary batteries) have been illustrated here as an embodiment, the scope of the present invention is not limited to this embodiment. The present invention may be applied to various forms of batteries such as, for example, cylindrical batteries and prismatic batteries.

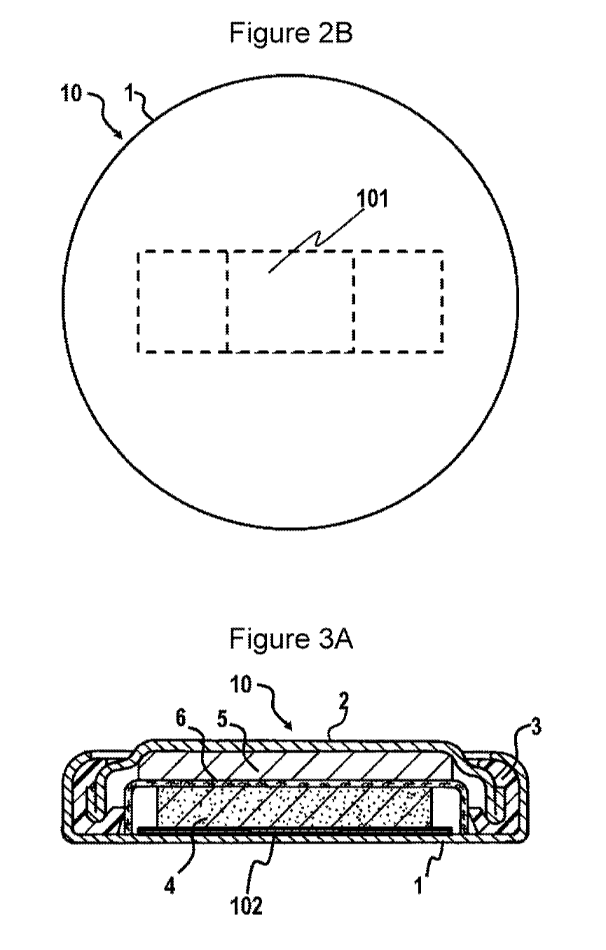

Modified examples representing other embodiments will be illustrated below with reference to FIGS. 2A to 5B.

A lithium battery illustrated in FIGS. 2A and 2B includes a disk-shaped positive electrode, a disk-shaped negative electrode, a separator disposed between the positive electrode and the negative electrode, and a nonaqueous electrolyte which is not shown, and has a diameter of 20 mm and a height of 5.0 mm. Between the positive electrode and the battery case, a current collector member 101 is disposed which is formed by welding stainless steel 5 mm in width, 5 mm in length and 0.1 mm in thickness to a central portion of stainless steel 5 mm in width, 17 mm in length and 0.1 mm in thickness. The current collector member 101 is welded to the battery case. This unit will be referred to as the current collector structure S2.

The configuration illustrated in FIG. 1 which does not have any specific current collector member between the positive electrode and the battery case will be referred to as the current collector structure S1.

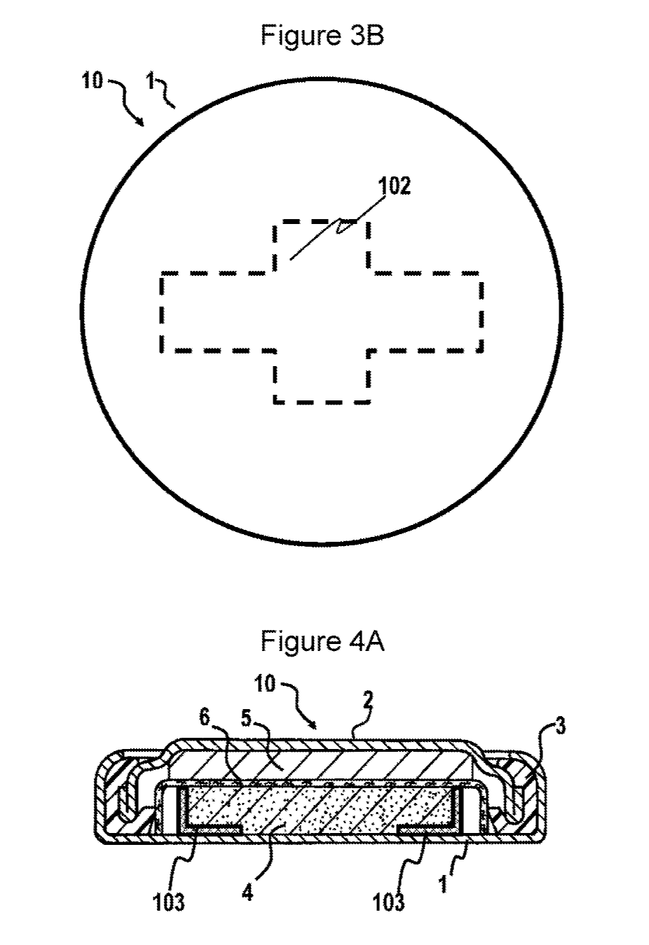

A lithium battery illustrated in FIGS. 3A and 3B includes a disk-shaped positive electrode, a disk-shaped negative electrode, a separator disposed between the positive electrode and the negative electrode, and a nonaqueous electrolyte which is not shown, and has a diameter of 20 mm and a height of 5.0 m. Between the positive electrode and the battery case, a current collector member 102 is disposed which is made of 0.1 mm thick stainless steel having a longer side 5 mm in width and 17 mm in length and a shorter side 5 mm width and 15 mm in length. The current collector member 102 is welded to the battery case. This unit will be referred to as the current collector structure S3.

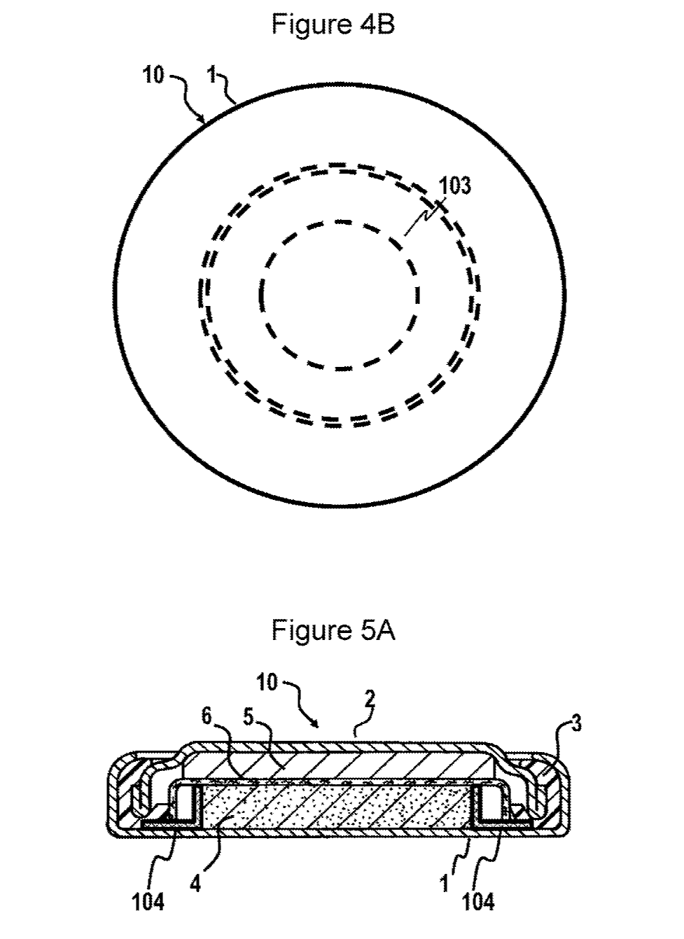

A lithium battery illustrated in FIGS. 4A and 4B includes a disk-shaped positive electrode, a disk-shaped negative electrode, a separator disposed between the positive electrode and the negative electrode, and a nonaqueous electrolyte which is not shown, and has a diameter of 20 mm and a height of 5.0 mm. Further, a current collector member 103 which is made of 0.1 mm thick stainless steel, is 15.2 mm in diameter and 3 mm in height, and has a bottom hole with a diameter of 4 mm is disposed so as to cover the lateral side of the positive electrode and a portion of the bottom of the positive electrode. The current collector member 103 is welded to the battery case. This unit will be referred to as the current collector structure S4.

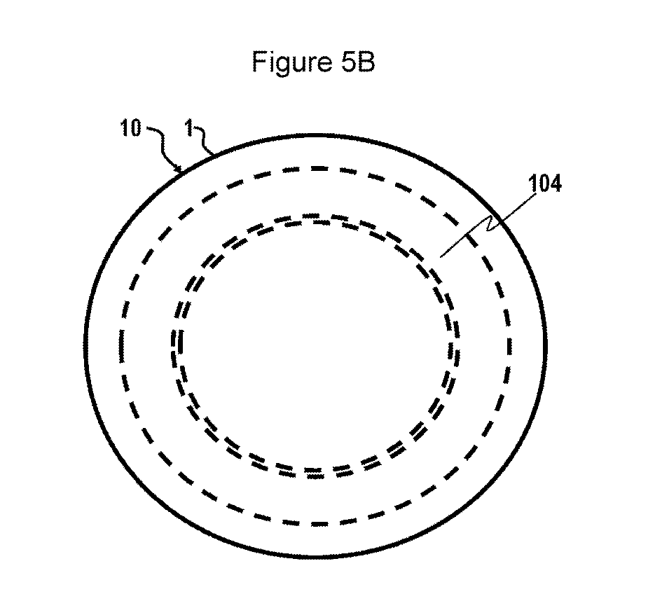

A lithium battery illustrated in FIGS. 5A and 5B includes a disk-shaped positive electrode, a disk-shaped negative electrode, a separator disposed between the positive electrode and the negative electrode, and a nonaqueous electrolyte which is not shown, and has a diameter of 20 mm and a height of 5.0 mm. Further, a current collector member 104 which is made of 0.1 mm thick stainless steel, has a cylindrical portion 15.2 mm in diameter and 2.9 mm in height, and has a doughnut-shaped peripheral portion 18 mm in diameter is disposed so as to cover the lateral side of the positive electrode and a portion of the bottom of the positive electrode. Part of the peripheral portion is disposed between the battery case and a gasket. This unit will be referred to as the current collector structure S5.

A coin-type lithium battery (a battery A5) was fabricated in the same manner as the battery A1, except that the battery structure was changed to that illustrated in FIGS. 2A and 2B.

Further, a coin-type lithium battery (a battery B6) was fabricated in the same manner as the battery B3, except that the battery structure was changed to that illustrated in FIGS. 2A and 2B.

A coin-type lithium battery (a battery A6) was fabricated in the same manner as the battery A1, except that the battery structure was changed to that illustrated in FIGS. 3A and 3B.

Further, a coin-type lithium battery (a battery B7) was fabricated in the same manner as the battery B3, except that the battery structure was changed to that illustrated in FIG. 2.

A coin-type lithium battery (a battery A7) was fabricated in the same manner as the battery A1, except that the battery structure was changed to that illustrated in FIGS. 4A and 4B.

Further, a coin-type lithium battery (a battery B8) was fabricated in the same manner as the battery B3, except that the battery structure was changed to that illustrated in FIGS. 4A and 4B.

A coin-type lithium battery (a battery AB) was fabricated in the same manner as the battery A1, except that the battery structure was changed to that illustrated in FIGS. 5A and 5B.

Further, a coin-type lithium battery (a battery B9) was fabricated in the same manner as the battery B3, except that the battery structure was changed to that illustrated in FIGS. 5A and 5B.

The batteries fabricated as described above were aged. The OCV and IR of the batteries before and after the aging were measured in the same manner as described in [Evaluation of batteries] hereinabove, and ΔOCV and ΔIR were determined. The results are described in Table 4. In Table 4, A2, A5, A6, A7 and A8 correspond to EXAMPLES of the present invention, and B3, B6, B7, B8 and B9 correspond to COMPARATIVE EXAMPLES.

TABLE 4

| | | | | | Current | ΔOCV (mV) | | ΔIR (Ω) | |
|---|---|---|---|---|---|---|---|---|---|
| | | | | | collector | Before | After | Before | After |
| Batteries | C coat | LiBF₄ | LiPO₂F₂ | LiN(FSO₂)₂ | structure | aging | aging | aging | aging |
| A2 | Present | 8.8 | 1 | 0 | 1 | 3 | 4 | 0.2 | 0.1 |
| B3 | Present | 8.8 | 0 | 0 | 1 | 23 | 10 | 1.0 | 0.4 |
| A5 | Present | 8.8 | 1 | 0 | 2 | 3 | 3 | 0.2 | 0.1 |
| B6 | Present | 8.8 | 0 | 0 | 2 | 28 | 11 | 1.2 | 0.4 |
| A6 | Present | 8.8 | 1 | 0 | 3 | 4 | 3 | 0.2 | 0.1 |
| B7 | Present | 8.8 | 0 | 0 | 3 | 29 | 11 | 1.4 | 0.4 |
| A7 | Present | 8.8 | 1 | 0 | 4 | 3 | 3 | 0.2 | 0.1 |
| B8 | Present | 8.8 | 0 | 0 | 4 | 29 | 12 | 1.4 | 0.5 |
| A8 | Present | 8.8 | 1 | 0 | 5 | 4 | 4 | 0.2 | 0.1 |
| B9 | Present | 8.8 | 0 | 0 | 5 | 30 | 13 | 1.5 | 0.5 |

As shown in Table 4, the example batteries had substantially no variation in OCV before aging. This result means that the preliminary discharging and aging of assembled batteries can be simplified or omitted. Further, in each of the example batteries, there was substantially no variation in IR before aging. This result too means that the preliminary discharging and aging of assembled batteries can be simplified or omitted. The upper limit of ΔOCV indicating an acceptable variation is empirically estimated to be about 15 mV, and the upper limit of ΔIR is empirically estimated to be about 1.0Ω.

In contrast, the comparative example batteries showed a variation in OCV before aging, and the ΔOCV was more than 20 mV in each case. Further, the IR before aging was variable in each of the comparative example batteries, and the ΔIR was 1.0Ω or more in each case.

Of the comparative example batteries, the comparative example batteries B6, B7, B8 and B9 which had the current collector structures S2, S3, S4 and S5 showed larger variations before aging, with ΔOCV being 28 mV or more and ΔIR being 1.2Ω or more, compared to the comparative example batteries B3 which involved the current collector structure S1. Further, the values of ΔOCV and ΔIR after aging, although being below the upper limits, were still large, with ΔOCV being 10 mV or more and ΔIR being 0.4Ω or more.

On the other hand, the example batteries which had the carbon coat and contained LiBF₄ and LiPO₂F₂ as additives showed substantially no variations in OCV and IR before aging regardless of the types of the current collector structures.

The comparative example batteries which had the carbon coat, contained LiBF₄ as an additive and contained no LiPO₂F₂ as an additive and which had the current collector structure 2, 3, 4 or 5 showed larger variations in OCV and IR compared to the comparative example batteries which had the current collector structure S1. The reasons for this result are probably as described below.

In the current collector structures S2, S3, S4 and S5, the current collector member is disposed between the bottom of the battery case and the positive electrode, and/or on the lateral side of the positive electrode. Thus, gaps are produced between the battery case and the current collector member, at the interface between the current collector members, and on the outside of the current collector member on the lateral side of the positive electrode. In such gaps, no contact with the positive electrode is obtained. When the nonaqueous electrolyte is poured into the battery, the nonaqueous electrolyte is brought into contact with such gaps present between the battery case and the current collector member, at the interface between the current collector members, and on the outside of the current collector member on the lateral side of the positive electrode, and accumulates there without contact with the positive electrode. Such accumulation reduces the amount of the nonaqueous electrolyte available for permeation into the porous layer on the negative electrode and to the surface of lithium in the negative electrode, and consequently the nonaqueous electrolyte fails to be in contact with the porous layer on the negative electrode and the surface of lithium over a sufficient area. These are probably the reasons behind the increased variations in OCV and IR before aging.

The example batteries which had the carbon coat and contained LiBF₄ and LiPO₂F. as additives and which had the current collector structure S2, S3, S4 or S5 attained suppressed variations in OCV and IR compared to the comparative example batteries which had the same current collector structure. The reasons for this result are probably as described below.

In the current collector structures S2, S3, S4 and S5, the current collector member is disposed between the bottom of the battery case and the positive electrode, and/or on the lateral side of the positive electrode. Thus, gaps are produced between the battery case and the current collector member, at the interface between the current collector members, and on the outside of the current collector member on the lateral side of the positive electrode. In such gaps, no contact with the positive electrode is obtained. When the nonaqueous electrolyte was poured into the example batteries which had the carbon coat and contained LiBF₄ and LiPO₂F₂ as additives, a quality film containing elementary boron (B) and elementary phosphorus (P) was formed on the porous layer on the negative electrode and/or on the surface of lithium in the negative electrode. This film allowed the porous layer and the surface of lithium to be well permeated with the nonaqueous electrolyte, and suppressed the accumulation of the nonaqueous electrolyte without contact with the positive electrode which occurred in the comparative examples at the gaps between the battery case and the current collector member, at the interface between the current collector members, and on the outside of the current collector member on the lateral side of the positive electrode. Consequently, the porous layer on the negative electrode and the surface of lithium were sufficiently permeated with the nonaqueous electrolyte even before aging, and the nonaqueous electrolyte attained a contact with the porous layer on the negative electrode and with the surface of lithium over an increased area. These are probably the reasons why the variations in OCV and IR before aging were reduced.

The shapes of the current collector members are not limited to those illustrated above, and may be other shapes such as circles, ellipses, squares, polygons and stars. The current collector members may be perforated.

The current collector structures described above may be used singly or in combination with one another. (For example, the current collector structure S2 and the current collector structure S4 may be combined.) When such a combination is adopted, gaps will be produced also at the interface between the current collector members, and therefore greater advantage can be taken of the effect of reducing the variations in OCV and IR before aging realized by the configuration of the present invention.

### INDUSTRIAL APPLICABILITY

The lithium batteries of the present invention are suited for driving devices at a wide range of temperatures, for example, −40° C. to 125° C. The lithium batteries of the present invention can be applied to, for example, tire pressure monitoring (management) systems (TPMS).

### REFERENCE SIGNS LIST

1: battery case (positive electrode terminal)
2: sealing plate (negative electrode terminal)
3: gasket
4: positive electrode
5: negative electrode
6: separator
10: lithium battery
101-104: current collector members

1. A lithium battery comprising a positive electrode, a negative electrode containing lithium, and a lithium ion conductive nonaqueous electrolyte, wherein
the positive electrode includes at least one selected from the group consisting of manganese oxide and graphite fluoride;
the lithium battery includes a powdery or fibrous material attached to at least a portion of a surface of the negative electrode opposed to the positive electrode;
the nonaqueous electrolyte includes a nonaqueous solvent, a solute and additives;
the solute includes LiClO₄; and
the additives include LiBF₄ and an oxyfluorophosphate salt.

2. The lithium battery according to claim 1, wherein the additives further include a salt which has an inorganic anion containing sulfur and fluorine.

3. The lithium battery according to claim 1, wherein per 100 parts by mass of the solute,
the amount of the LiBF₄ is 4 to 20 parts by mass, and
the amount of the oxyfluorophosphate salt is 0.2 to 2.5 parts by mass.

4. A lithium battery comprising a positive electrode, a negative electrode containing lithium, and a lithium ion conductive nonaqueous electrolyte, wherein
the positive electrode includes at least one selected from the group consisting of manganese oxide and graphite fluoride;
the lithium battery includes a powdery or fibrous material attached to at least a portion of a surface of the negative electrode opposed to the positive electrode;
the nonaqueous electrolyte includes a nonaqueous solvent and a solute;
the solute includes LiClO₄; and
the negative electrode includes elementary boron and elementary phosphorus.

5. The lithium battery according to claim 4, wherein the negative electrode contains:
elementary boron in an amount of 0.1 μg to 3 μg, and
elementary phosphorus in an amount of 0.2 μg to 2.5 μg
per 1 umm area of the surface of the negative electrode opposed to the positive electrode.

6. The lithium battery according to claim 4, wherein the nonaqueous electrolyte further includes additives; and
the additives include LiBF₄ and an oxyfluorophosphate salt.

7. The lithium battery according to claim 1, wherein the powdery or fibrous material is a carbon material.

8. The lithium battery according to claim 7, wherein the carbon material is attached to a nonwoven fabric.

9. The lithium battery according to claim 1, wherein the nonaqueous solvent includes a cyclic carbonate ester and a chain ether.

10. The lithium battery according to claim 1, wherein both the positive electrode and the negative electrode have a disk shape.

11. The lithium battery according to claim 10, wherein the disk-shaped positive electrode and negative electrode are accommodated via a separator in a case having a circular bottom and a lateral side rising from the edge of the bottom, and a current collector member is disposed between the bottom of the case and the positive electrode, and/or on a lateral side of the positive electrode.
